(19) United States
(12) Patent Application Publication
(10) Pub. No.: US 2005/0193611 A1
(43) Pub. Date: Sep. 8, 2005

(54) Display holder

(76) Inventor: Patrick Nicholas Lennard, Aylesbury (GB)

Correspondence Address: PAUL E MILLIKEN, 9061 WALL STREET, NW, MASSILLON, OH, 44646-1676, US

(21) Appl. No.: 10/794,265

(22) Filed: Mar. 5, 2004

(51) Int. Cl. G09F 3/18

(52) U.S. Cl. 40/661

(57) ABSTRACT

A display holder, comprising a flat rectangular sleeve (1) for receiving a sheet (2) to be displayed, the sleeve (1) comprising a transparent front panel (3) and a rear panel (4) both made of plastics material and being scaled around the whole of its periphery by a weld (8). The rear panel (4) has an aperture (10) therein spaced from the periphery to facilitate insertion of a sheet (2) into the sleeve (1), the aperture being closable after insertion of the sheet by a layer of waterproof material fixed over the aperture by adhesive. The aperture may be an elongate slit (10) which is sealed by means of self adhesive tape (11).

### FIELD

This invention relates to a display holder for displaying inserts bearing media such as advertisements, notices, warning signs, menu cards and the like.

### BACKGROUND OF THE INVENTION

It has been proposed to provide a display holder comprising hinged front and back plastics material members. An insert in the form of a sheet of paper or card bearing the notice, advertisement or whatever is placed between the members and the latter are then held together by integral clip portions of the members. Another proposal comprises a rectangular plastics sleeve closed along three edges and with the fourth edge closable by a flap. The sleeve may be secured to a relatively stiff support panel such as a sheet of Correx™.

Display holders are often put up outside, e.g. on lampposts and telegraph poles. To keep the contents in good condition, they need to be weatherproofed. With known holders, water can enter the holder at the corners, e.g. where the aforementioned flap reaches the adjacent sides of the holder. In addition, with known proposals, there are exchanges of the air inside and outside the holder, due to daily temperature variations for example, and this tends to cause the contents of the holder to be subject to increased humidity overall. This accelerates deterioration of the contents.

An object of the invention is to provide a display holder which may be preferred, particularly for economy of manufacture while providing total prevention of air and water entry.

### STATEMENTS OF INVENTION

According to the invention there is provided a display holder comprising a flat rectangular sleeve for receiving a sheet to be displayed, the sleeve comprising a front and a rear panel made of plastics material and the sleeve being sealed around the whole of its periphery, said rear panel having a aperture therein spaced from said periphery and operable for permitting insertion of said sheet into said sleeve, and said aperture being closable after such insertion by a layer of waterproof material fixed over the aperture by adhesive.

Preferably, said aperture is a narrow elongate slot.

In one embodiment, the sleeve comprises an exterior flap positioned for overlaying said aperture and for being fixed over the aperture by adhesive.

Preferably, the flap supports a layer of adhesive for use in fixing said flap over the aperture.

Advantageously, said layer of adhesive extends over the whole of that surface of the flap which faces the aperture including right up to the extreme edge of the flap to prevent any tendency for the said edge to lift from the sleeve.

The aperture can extend parallel to and relatively close to one edge of said sleeve, and the flap may be a full-length flap fixed to the sleeve along said one edge such that the flap can overlie said aperture.

Preferably, the panels are sealed to one another by welding and the flap is fixed to the sleeve by being incorporated in the weld at said one edge.

Said plastics material may be poly-vinyl chloride (PVC).

The front and rear panels may each have a thickness of between 250 and 500 Microns, preferably this thickness is 300 Microns.

The sleeve may have two longer edges and two shorter edges and the said aperture can be elongate and extend parallel to and relatively near to one of said two longer edges.

Instead of PVC, some other plastics material may be used for the panels, for example one of polypropylene PET polyester acrylic and polycarbonate.

Then the holder may include weld means, for example one or more spot-welds, joining the front and rear panels for locating the said sheet.

It is not essential to provide the flap. Instead, a separate length of weatherproof adhesive sealing tape can be used to seal the aperture.

For mounting said display holder in a position of use, it may comprise one or more loops affixed to the back of the sleeve. Alternatively. or in addition, one or more lands may be formed in the sleeve, for example at respective corners of the sleeve, for receiving pins or nails to fix the display holder to a notice board or the like. Also, the mounting means could comprise a self-adhesive block for attachment to said rear panel and tie means for being engaged in an aperture in said block and tied to a support.

### DESCRIPTION OF THE DRAWINGS

An embodiment of the invention will now be described by way of example with reference to the accompanying drawings, in which:

FIG. 1 is a rear elevation of a first embodiment of a display holder;

FIG. 2 is a section on line II-II in FIG. 1;

FIG. 3 is perspective view of the FIG. 1 display holder mounted on a pole;

FIG. 4 is a section on line IV-IV in FIG. 3;

FIG. 5 is a perspective view of a cable tie and cable tie base;

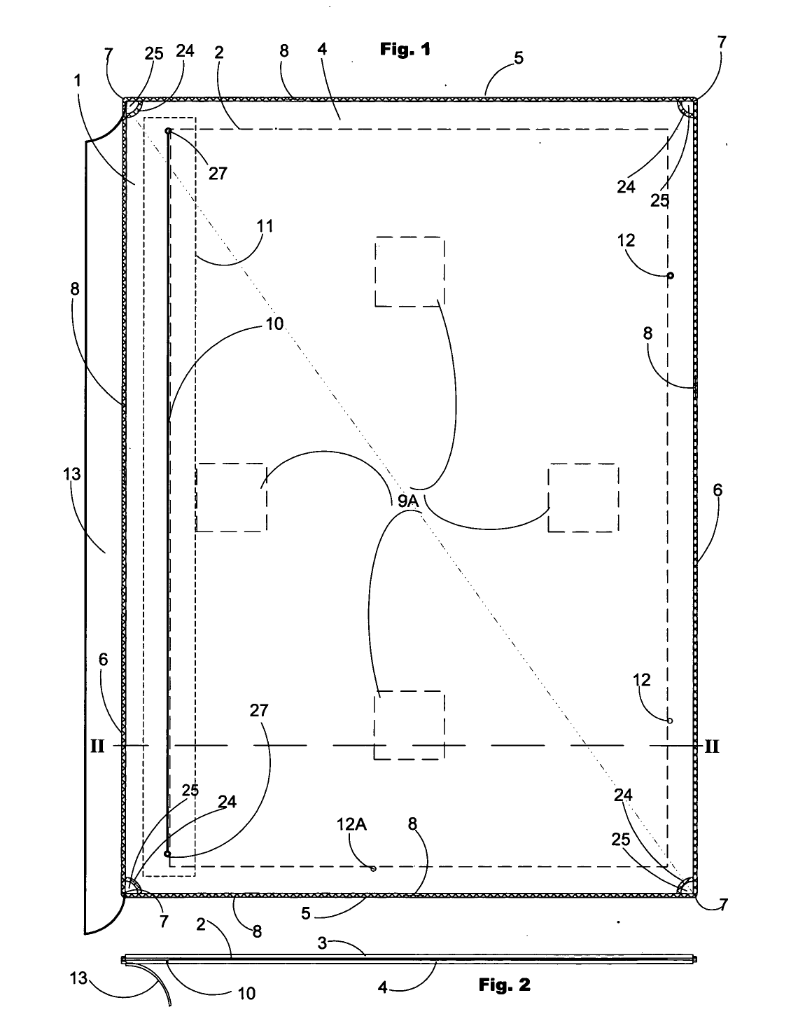

### DETAILED DESCRIPTION OF THE INVENTION

The display holder shown comprises a flat rectangular sleeve 1 able to receive a sheet 2 of paper or card bearing an advertisement, notice or the like to be displayed. The sleeve comprises front and rear panels 3 and 4 respectively. The panels are made of poly-vinyl chloride (PVC) and the sleeve is sealed around the whole of its periphery, i.e., along the two shorter edges 5 and the two longer edges 6 of the panels 3 and 4 and right up to the corners 7 by welding, preferably electronic welding. The width of the weld 8 is quite substantial to maintain the seal.

The front panel 3 is transparent while the rear panel 4 is opaque. Instructions, templates and/or diagrams may be printed on the rear surface of the rear panel 4 to assist the user. In the present case, four squares 9 are printed on the panel 4 to show the best positions for a display holder mounting device—this will be described later.

The front panel 3 could also carry printed matter, for example standard information to be included in notices put out by the owner of the display holder or a logo identifying such owner.

The rear panel 4 has a slit 10 formed therein. The slit is parallel to and is relatively close to, but spaced from, one of the longer edges 6 of the sleeve. Its function is to permit insertion of the sheet 2 into the sleeve. The slit 10 terminates in a circular punched hole at its ends to make it expandable and hence easier to insert the sheet 2 with less danger of tearing of the panel.

At this one edge of the sleeve near the slit 10, there is a flap 13, which extends from the edge, where it is fixed by being incorporated in the weld 8 at this edge, down over the slit. The flap 13 extends the full length of the sleeve 1 and is large enough to extend well past the slit. The underneath surface of the flap carries a layer of weatherproof low-tack adhesive thereon. The adhesive extends right up to the edges of the flap. The adhesive is used to seal the flap down onto and around the slit.

The reason for using low tack adhesive extending right up to the edges of the flap is to better prevent the possibility of wrinkling of the flap due to temperature variation induced differential expansion of the flap 13 and rear panel 4, and lifting of the flap at the edges after the flap has been stuck down.

The panels 3 and 4 may each have a thickness of between 250 and 500 Microns. For preference, the thickness is 300 Microns, especially if the plastics material is PVC.

Instead of PVC, the panels 3 and 4 could be made of another sheet plastics material such as polypropylene or PET. Other suitable materials are polyester acrylic and polycarbonate. The best thickness for these other materials may or may not be the same as that for PVC. For example, 500 Microns may be best for PET. In general, the thickness should be just sufficient for the holder, i.e. the two panels 3 and 4 together, to stand upright on one edge. This is not essential in all cases however. A suitable thickness can be chosen by experimentation having regard to the expected application of the holder. Thus, a stand up table menu holder might need to be thicker and hence stiffer than a notice holder to be attached to a window. It may be preferable to use a semi-rigid plastics material rather than one which is generally quite flexible

In the embodiment shown, the rear panel is opaque but this is not essential. In fact, it may be advantageous in some situations for the panel 4 to be transparent. For example, this might be appropriate if the holder is used for an application such as a tabletop menu card.

Whether or not the panel 4 is transparent, the aforementioned printed instructions, templates and such may or may not be provided.

The panel 3, and the panel 4 if it is transparent, could be provided with a non-glossy (matt) anti-glare surface finish.

The illustrated display holder is intended for display of an A4 size sheet and the internal dimensions of the sleeve could be 330 mm by 245 mm, and the slit could be 303 mm long and positioned centrally between the edges 6. The slit can be 15 mm from the nearest edge 6 and, if used, the tape 11 can be 20 mm wide by 325 mm long. Each spot weld 12 can be 15 mm from the adjacent edge 6 of the sleeve and say 70 mm from the nearest edge 5. The spot weld 12A can be 15 mm from the adjacent edge 5 of the sleeve and say 100 mm from the nearest edge 6.

Depending upon which material is used for the panels 3 and 4 (it may not be appropriate when PVC is used), two spot welds 12 and one spot weld 12A may be formed between the panels 3 and 4 to form supports for the sheet 2. The holder can be used with the shorter sides at top and bottom to give a portrait position of the holder or at left and right to give a landscape position.

The lower edge of the sheet 2 will be spaced above the lower edge of the display holder and maintained by the spot weld 12A in portrait position and the spot-welds 12 when in landscape position.

To mount the display holder in a position of use, it is supplied with a suitable mounting item. For example, a clear adhesive tab or piece of double-sided adhesive tape for fixing the holder to a wall or window, or a weighted base with a clip or slot for standing the holder on a table.

To assist in fixing the display holder to a notice board, the illustrated display holder is provided with weld lines 24 cutting off the corners 7 of the sleeve 1 so as to define lands 25. The holder can then be pinned to the notice board by drawing pins or nails (not shown) through the lands 25. The weld lines 24 are made continuous with the weld lines 8 so that the perforations made by the pins or nails do not compromise the sealing of the sleeve.

The lands at the corners of the sleeve may be provided with punched holes for receiving central spigot portions of respective suction cup fixings (not shown).

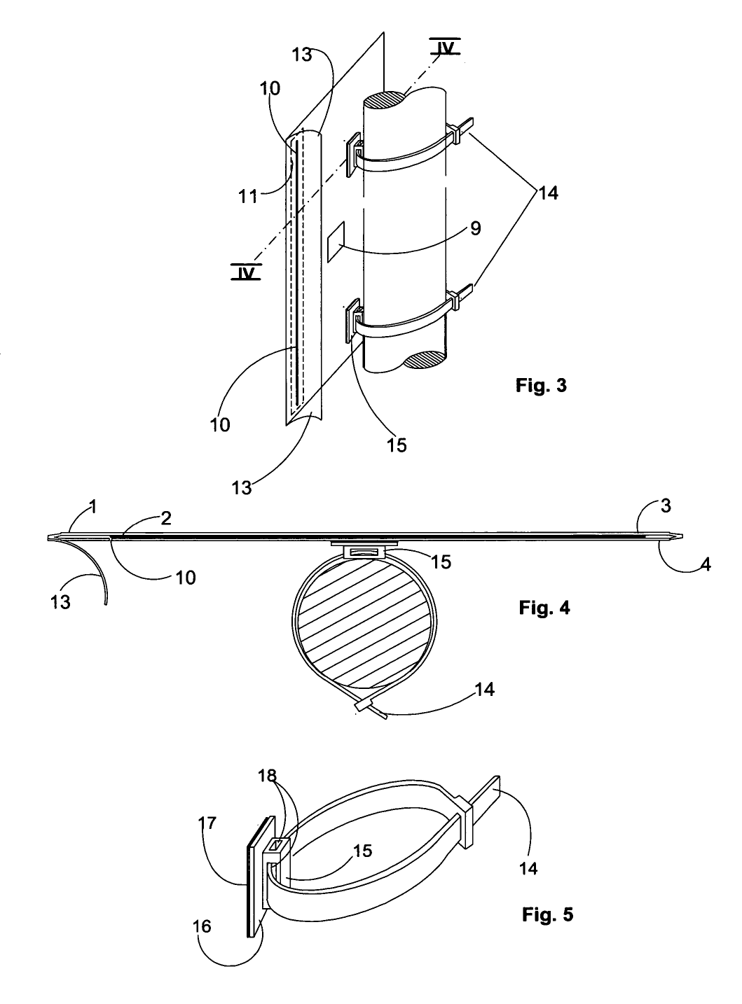

To mount the display holder outside on a vertical post, e.g. a street lamp, as shown in FIGS. 3 and 4, the holder may be supplied with two self-locking cable ties 14 and two adhesive cable tie bases 15.

A self-locking cable tie is a well known item used in the electrical industry for tying bundles of electrical cables together but also having other uses as here. It comprises a plastics material strip with serrations along its length and an eyelet at one end with a catch in the eyelet. The other end of the strip can be inserted in the eyelet whereupon the catch engages the serrations with a non-return action allowing the tie to be tightened around a bundle of cables or indeed a lamppost. In some cases, the catch can be disengaged to permit loosening of the tie.

The adhesive cable tie base 15 is also a known item. It comprises a shallow plastics material block 16 with an adhesive layer 17 on one side, covered when sold by a peel-off protective film (not shown). One or more slots 18 extend through the block for receiving the cable tie. In use, the adhesive layer 17 is exposed and the block 16 attached to a suitable position on the rear panel of the display holder. Suitable positions for the block 16 are indicated by the four printed squares 9 on the panel 4, two of the squares being best for portrait mounting of the holder and the other two for landscape mounting. The cable tie 14 is then inserted through an appropriate one of the slots 18. The tie 14 is then tightened around the lamppost to secure the display holder.

In a modification of the display holder, the flap 13 is omitted and, in its place, the holder is supplied (for example, as part of a pre-packed kit of parts) with a separate pre-cut length of weatherproof adhesive sealing tape 11. Ideally the adhesive tape 11 has the adhesive side covered by a peel-off protective layer and this protective layer is removed when the tape is about to be used. As shown in dashed outline in the drawings, the supplied length of tape is carefully applied to the panel 4 over the slit 10 after the sheet 2 has been inserted into the sleeve 1.

For this embodiment, the tape could 20 mm wide by 325 mm long.

The tape 11 does not have to be a pre-cut piece of course. It could be simply cut from a separately purchased reel. Either way, however, the piece should be longer and substantially wider than the slit 10 so that, when it is applied over the slit, it can be ensured that the sides and ends of the slit are well covered.

The sides and ends of the slit are sufficiently well spaced from the edges of the panel so that the tape can be applied all round the slit without touching the panel edges. However, the slit is reasonably close to the closest edge 6 so as to make it easier to insert the sheet 2 without having to make the sleeve much bigger than the sheet 2 to be displayed. In this embodiment, the slit could be 15 mm. from the nearest edge 6, or it could be between 10 and 15 mm. from that edge, or it could be between 5 and 15 mm. or 5 and 20 mm. from that edge. The slit 10 could have a length and a position on the panel 4 such that each end of it extends to no less than 4 mm. from the closest edge 5 of the sleeve. Better still, each end of the slit should be no less than 5 mm. or even better no less than 6 mm. or even better than that 7, 8 or 9 mm. from the closest edge 5. Each end of the slit could be 10 mm. or less from the edge 5 of the panel.

The illustrated display holder is re-usable, i.e. the media item therein can be taken out and replaced if required or the holder may be taken down and put up in a different position.

The term slit as used herein in relation to the slit 10 means a very narrow elongate aperture of knife cut thickness say. However, this is not essential—instead the slit 10 could be replaced by a somewhat wider slot or aperture, say a slot one, two, three or even four or five mm. wide or perhaps even wider than this, provided that the slot or aperture can be effectively sealed by the application of the flap 13 or the separate tape 11.

The cable tie base 15 could be of the kind disclosed in GB Patent Application No. 0016850.0, namely in which the block has projecting wings to give improved support to the display holder.

The display holder may be dimensioned to receive sheets of sizes other than A4. For example, it may be dimensioned to take A3 sheets or other metric, imperial or US sizes.

Particularly for sizes greater than A4, additional welded lands such as lands 25 may be provided to permit extra support of the holder. For example, there could be two intermediate lands half way along the long edges of the sleeve.

1. (canceled)

2. A display holder according to claim 21, wherein said aperture is a narrow elongate slit.

3. A display holder according to claim 21, wherein the sleeve further comprises an exterior flap positioned for overlaying said aperture and for being fixed over the aperture by adhesive.

4. A display holder according to claim 3, wherein the flap supports a layer of adhesive for use in fixing said flap over the aperture.

5. A display holder according to claim 4, wherein said layer of adhesive extends over the whole of that surface of the flap which faces the aperture including right up to the extreme edge of the flap to prevent any tendency for the said edge to lift from the sleeve.

6. A display holder according to claim 2, wherein the aperture extends parallel to and relatively close to one edge of said sleeve, and the flap is fixed to the sleeve along said one edge such that the flap can overlie said aperture.

7. A display holder according to claim 6, wherein the panels are sealed to one another around the entire periphery by welding and the flap is fixed to the sleeve by being incorporated in the weld at said one edge.

8. (canceled)

9. (canceled)

10. A display holder according to claim 21, wherein said plastics material is one of polyvinyl chloride (PVC), a polyolefin, PET, polycarbonate and a polyester acrylic.

11. A display holder according to claim 10, wherein said front and rear panels each have a thickness of between 250 and 500 Microns.

12. A display holder according to claim 21, further including spot welds joining the front and rear panels for locating said sheets within the sleeve.

13. A display holder according to claim 2, the waterproof material comprising a length of adhesive sealing tape applied over said slit.

14. (canceled)

15. (canceled)

16. (canceled)

17. (canceled)

18. A display holder as claimed in claim 21 wherein the lands are each formed in a respective corner of the sleeve.

19. A display holder according to claim 20, wherein said loops are formed by tie means which are affixed to the back of the sleeve by at least one self-adhesive block which attaches to said rear panel with the tie means being engaged in said block for securing the holder to a support.

20. A display holder comprising a flat rectangular sleeve for receiving a sheet to be displayed, the sleeve comprising a transparent front panel and a rear panel which are made of plastics material with the sleeve being scaled around the whole of its periphery, said rear panel having an aperture therein spaced from said periphery and operable for permitting insertion of said sheet into said sleeve, and said aperture being closable after such insertion by a layer of waterproof material fixed over the aperture by adhesive, and further including mounting means for mounting said display holder in a position of use, said mounting means comprising one or more loops affixed to the back of the sleeve.

21. A display holder comprising a flat rectangular sleeve for receiving a sheet to be displayed, the sleeve comprising a transparent front panel and a rear panel which are made of plastics material with the sleeve being sealed around the whole of its periphery, said rear panel having an aperture therein spaced from said periphery and operable for permitting insertion of said sheet into said sleeve, and said aperture being closable after such insertion by a layer of waterproof material fixed over the aperture by adhesive and further including mounting means for mounting said display holder in a position of use. said mounting means comprises one or more lands formed in an edge margin of the sleeve for receiving pins to fix the display holder to a notice board

22. A display holder as claimed in claim 21, the mounting means additionally comprising one or more loops affixed to the back of the sleeve.

23. A display holder as claimed in claim 2 wherein the elongate slit extends parallel to and adjacent one edge of said sleeve
